(19) United States
(12) Patent Application Publication
(10) Pub. No.: US 2015/0019984 A1
(43) Pub. Date: Jan. 15, 2015

(54) METHOD AND SERVER FOR PROCESSING REPORT DATA

(71) Applicant: Tencent Technology (Shenzhen) Company Limited, Shenzhen (CN)

(72) Inventors: Haidong JIN, Shenzhen (CN); Chengtao FAN, Shenzhen (CN); Yuepeng QIU, Shenzhen (CN); Gongwei LI, Shenzhen (CN); Gang WANG, Shenzhen (CN); Haiyang ZHU, Shenzhen (CN); Zejun WU, Shenzhen (CN); Baitao HUANG, Shenzhen (CN); Ciuping WANG, Shenzhen (CN); Kai ZHU, Shenzhen (CN); Xiaoling LIN, Shenzhen (CN)

(73) Assignee: Tencent Technology (Shenzhen) Company Limited

(21) Appl. No.: 14/496,634

(22) Filed: Sep. 25, 2014

Related U.S. Application Data
(63) Continuation of application No. PCT/CN2014/081563, filed on Jul. 3, 2014.

(30) Foreign Application Priority Data
Jul. 12, 2013 (CN) 201310293979.1

(51) Int. Cl. H04L 29/08; G06F 3/0482; G06F 3/0486

(52) U.S. Cl. CPC H04L 67/10; G06F 3/0486; G06F 3/0482
USPC 715/739

(57) ABSTRACT

A method and server for processing report data are disclosed according to the disclosure. The method includes: receiving a download identifier in a download area of a browser, where the download identifier is dragged into the download area by a drag operation; generating a first report data based on the received download identifier and displaying the first report data in the download area of the browser, the first report data being associated with the download identifier; receiving a delete operation for the download identifier, generating the second report data based on a remained download identifier and displaying the second report data in the download area, where the second report data is formed by screening the first report data and corresponds to the remained download identifier; sending the second report data based on a received downloading request.

### CROSS REFERENCE

This application is a continuation application of International Application No. PCT/CN2014/081563, titled “Method and Server for Processing Report Data”, filed on Jul. 3, 2014, which claims priority to Chinese Patent Application No. 201310293979.1 titled “Method and Server for Processing Report Data” and filed with the State Intellectual Property Office on Jul. 12, 2013, which are incorporated herein by reference in their entireties.

### FIELD OF THE TECHNOLOGY

The present disclosure relates to the field of the data processing technology, and particularly to a method and server for processing report data.

### BACKGROUND OF THE DISCLOSURE

With the increment of user data, how to effectively process the user data has been paid more and more attention in the field of the internet.

Taking downloading report data in a webpage as an example, there are currently two downloading methods. One is a single direct download method, i.e., downloading a whole report by clicking a download button corresponding to the report when browsing a webpage report, and sending by a server the data of the whole report to a download terminal in the form of a file when the server receives a download instruction. The other method is a shopping cart download way, i.e., dragging the reports to be downloaded into a shopping cart one by one, and then downloading all of the reports in the shopping cart.

During a process of researching, the whole report is needed to be downloaded no matter in the single direct download method or in the shopping cart download method. When a piece of data in multiple reports is needed to be viewed, the multiple reports are needed to be downloaded. Therefore, the download button is needed to be continuously clicked to download the reports in the single direct download method, and the multiple reports are needed to be added into the shopping cart through a cumbersome operation in the shopping cart download method. Furthermore, since most of the downloaded contents are not needed by the user, resources are wasted, network channels are occupied and the download rate is low.

### SUMMARY

In view of this, the present disclosure provides a method and server for processing report data, to enable downloading of the report data.

A method for processing report data, which includes:

receiving a download identifier in a download area of a browser, where the download identifier is dragged into the download area by a drag operation;

generating a first report data based on the received download identifier and displaying the first report data in the download area, where the first report data is associated with the download identifier;

receiving a delete operation for the download identifier, generating a second report data based on a remained download identifier, and displaying the second report data in the download area, where the second report data is formed by screening based on the first report data and the second report data corresponds to the remained download identifier; and

sending the second report data based on a received downloading request.

To solve the above issues, the following technical solutions are further provided according to an embodiment of the disclosure.

A server is provided, which includes:

a download identifier receiving module configured to receive a download identifier in a download area of a browser, where the download identifier is dragged into the download area by a drag operation;

a report data generating module configured to generate a first report data based on the received download identifier, receive a delete operation for the received download identifier, and generate a second report data based on a remained download identifier; wherein the first report data is associated with the received download identifier, the second report data is formed by screening based on the first report data and the second report data corresponds to the remained download identifier;

a report data displaying module configured to display the first report data and the second report data in the download area; and

a report data sending module configured to send the second report data based on a received downloading request.

In the embodiment of the disclosure, when browsing the report information in the browser, the user can directly drag the download identifier into the download area by a drag operation, and perform a screening process on the dragged download identifier in the download area, and the server sends report data corresponding to the download identifier to the downloading terminal. Apparently, in the embodiment of the disclosure, the download identifier may be directly dragged into the download area in a simple way; and the download identifier may be screened in the download area, with only a necessary download identifier being remained. Since the server sends the report data necessary for the user to the download terminal, the resources waste may be avoided and the downloading rate may be improved.

### BRIEF DESCRIPTION OF THE DRAWINGS

FIG. 1 is a schematic flowchart of a method for processing report data according to a first embodiment of the disclosure;

FIG. 2 is a schematic flowchart of a method for processing report data according to a second embodiment of the disclosure;

FIG. 3 is a schematic diagram of a server according to an embodiment of the disclosure.

FIG. 4 is a hardware structure diagram according to an embodiment of the invention.

### DETAILED DESCRIPTION OF THE DISCLOSURE

In the drawings, the same components are denoted by the same signs. The principle of the disclosure is exemplified by the implementation in an appropriate computing environment. The following description is based on the exemplified embodiment of the disclosure, and is not intended to limit the other embodiments of the disclosure which are not described herein.

In the following description, the embodiment of the disclosure is illustrated with reference to the steps and signs to be performed by one or more computers, unless otherwise specified. Therefore, it is mentioned several times that the steps and operations are to be performed by the computer. The computer execution herein includes the operation of a computer processing unit on the electronic signal of data in a structured form. The data is transformed or maintained in the memory of the computer by the operation which may reconfigure or change the operation of the computer by a way well known to the skilled in the art. The data structure of the data is a physical address in the memory with a specific property defined by the data format. However, the above description of the principle of the disclosure does not represent a limit, it will be understood by the skilled in the art that various steps and operations below may also be implemented by hardware.

The term “module” used herein refers to the software object to be executed on the computing system. Various components, modules, engines and service described herein refer to objects to be implemented on the computing system. The device and method described herein may be implemented by software or hardware which is within the protection scope of the present disclosure.

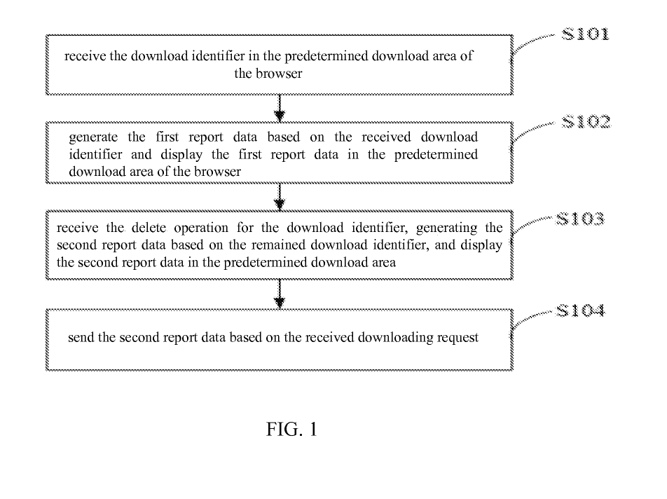

FIG. 1 is a schematic flowchart of a method for processing report data according to the first embodiment.

In Step S101, receiving the download identifier in a download area of a browser, where the download identifier is dragged into the download area by a drag operation.

The browser is provided in a download terminal. Webpage information (for example, report information) displayed in the browser is supplied by a server. For example, the server provides a webpage containing the report information and displays the webpage in the browser of the download terminal.

In one embodiment, the download identifier may be “date”, “login time”, “weekly activity” in the report information. The download identifier is dragged into the download area through a drag operation by a user, where the drag operation indicated in the embodiment may include dragging by a mouse, or dragging by a touch action on a touch screen interface. The download area is similar to the shopping cart in the shopping website, and may be configured to uniformly process the download identifier dragged by the user.

The download terminal is a communication terminal device, which is connected to the server, and communicates with the server through a communication network. A communication between the download terminal and the server may be send and receive the webpage information.

The download terminal may include not only a desktop computer, but also terminals with a storage unit and computing capability provided by an installed microprocessor, such as a laptop computer, a workstation, a palm computer, an ultra mobile personal computer (UMPC), a tablet computer, a PDA, a web pad, a portable phone. The communication network may include not only the data communication network including local area network (LAN), metropolitan area network (MAN), wide area network (WAN), Internet, but also the telephone network, regardless of communication mode, and no matter in wire or wireless form.

The server is a device for providing webpage content, which may be, for example, a video server for providing video content or a report server for providing report information.

In Step S102, generating a first report data based on the received download identifier and displaying the first report data in the download area.

In the specific implementation process, presetting a download area in a displaying interface of the browser to receive the download identifier dragged in through a drag operation by the user. After receiving by the download area the download identifier dragged in through the drag operation by the user, the server synchronously generates the first report data based on the download identifier and displays the first report data in the download area.

For example, if the user drags the “the user logged in over the last week” in the report information into the download area, the server generates all the report data associated with the “the user logged in over the last week” and displays all the acquired report data in the download area.

In Step S103, receiving a delete operation for the download identifier, generating a second report data based on a remained download identifier and displaying the second report data in the download area.

Specifically, after the server generates the first report data based on the download identifier dragged into the download area by the user and displays the first report data in the download area, the user may screen the download identifiers in the download area to delete the download identifier corresponding to the data information unnecessary for the user, for example, delete the “the user logged in over the last week”. After deleting the “the user logged in over the last week” by the user, the server synchronously deletes the “the user logged in over the last week” and all the data information associated with the “the user logged in over the last week”, generates the second report data based on the remained download identifier and displays the second report data in the download area.

In Step S104, sending the second report data based on a received downloading request.

A download button is provided in the download area. The user clicks the download button to send the downloading request for the second report data to the server after screening the download identifiers in the download area. The server sends the second report data to the download terminal after receiving the downloading request.

Surely, the user may click the download button to send the download instruction for the first report data to the server upon receiving the first report data, in a case where the user does not perform the screening process on the download identifiers. The server sends the first report data to the download terminal after the instruction is received.

Apparently, in the embodiment, the download identifier may be directly dragged into the download area by the user in a simple way; and the user may screen the download identifier in the download area, with only necessary download identifiers being remained. Since the server sends the corresponding report data required by the user to the download terminal, the resources waste may be avoided and the download rate may improved.

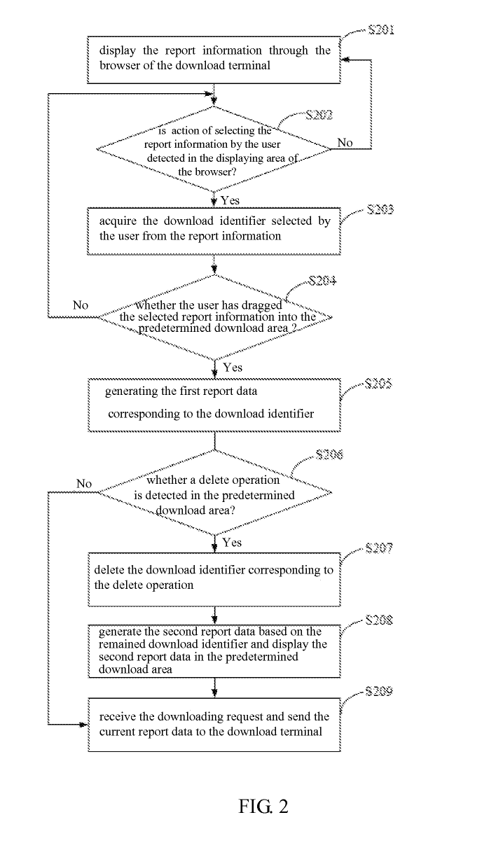

FIG. 2 is a schematic flowchart of the method for processing report data according to the second embodiment, which is illustrated by example of downloading the report data by the download terminal.

In Step S201, displaying the report information through the browser provided in the download terminal.

In the specific implementation process, the user opens the browser through the download terminal and opens the webpage containing the report information through the browser, surely, the webpage containing the report information is provided by the server.

In Step S202, determining whether an action of selecting the report information by the user is detected in the report information displaying process; in a case where the action of selecting the report information by the user is detected in the report information displaying process, performing Step S203, otherwise, proceeding with Step S201.

The action of selecting the report information includes: selecting the report information by a mouse or selecting the report information by a touch action on the touch screen interface. For example, the user selecting a row, a column or a download identifier in the report information by a mouse is considered as detection of the action of selecting the report information by the user. In a case where the download terminal (for example, a cell phone) is provided with a touch screen interface, the user selecting a row, a column or a download identifier in the report information through a touch action is considered as the action of selecting the report information.

In Step S203, acquiring the download identifier selected by the user in the report information.

Specifically, the user acquires a corresponding download identifier when selecting a row of report information by a mouse or by a touch action. The download identifier may include the report information identifier (ID) and the download identifier contained in the report information. For example, the user acquires the corresponding download identifier including the report identifier (ID) and date information in a case where the row of report information corresponding to a date is selected, where the record form for the download identifier is {reportId:’ ’ ,ftime:’ ’ ,dim:’ all’ ,data:’ all’ }, In the specific implementation process, the user may further select an index or a dimension in the report information by a mouse. The index is for example logged-in users during a period of time, and the dimension is the category basis for dividing, screening, and sorting the report information to be the report, such as date, advertising unit and country/region. At this time, the record form for the download identifier is {reportId:’ ’ ,ftime:’ all’ ,dim:array(‘ ’),data:array(‘ ’)}.

Surely, the user may further directly select the download identifier in the report information by a mouse or a touch action, for example, the “the user logged in over the last week” will be regarded as the download identifier in a case where the report information selected through a mouse or a touch action by the user is the “the user logged in over the last week”.

In Step S204, determining whether the user has dragged the selected report information into the download area by a drag action; in a case where the user has dragged the selected report information into the download area by the drag action, proceeding with Step S205, and otherwise, proceeding with Step S202.

There are many methods for determining whether the user has dragged the selected report information into the predetermined download area. For example, in a case where the user has dragged the selected report information into the download area by a drag action, whether the touch screen pressed by the user is lifted up in the download area is determined; if the touch screen pressed by the user is lifted up in the download area, it is determined that the user has dragged the selected report information into the download area; and if the touch screen pressed by the user is not lifted up in the download area, it is determined that the user has not dragged the selected report information into the download area.

In one embodiment, the drag action in the embodiment may include: dragging the selected report information by a mouse, or dragging the selected report information by a touch action on the touch screen interface.

In Step S205, generating the first report data corresponding to the download identifier and displaying the first report data in the download area.

In the specific implementation process, after the download identifier dragged in by the user through a drag action is received in the download area, the server synchronously acquires the download identifier and parses the acquired download identifier to acquire the first report data corresponding to the download identifier and display the acquired first report data through the download area, where the first report data is associated with the download identifier. For example, in a case where the user drags the “the user logged in over the last week” in the report information into the download area, then the server synchronously acquires all the report data related to the “the user logged in over the last week” and displays the acquired report data through the download area.

In the embodiment, the download identifier dragged in by the user may be uniformly processed in the download area. For example, the date information in a row is recorded as {reportId:’ ’ ,ftime: {‘ ’, ‘ ’},dim: {‘ ’},data: {‘ ’}} after the row of report information is dragged into the download area by the user. The report name, the selected dimension and index name, the time and so on displayed in the download area are all stored in the download area provided by the server. Screened contents of a report is the report data recorded by using a field, the list in the download area may be represented as:

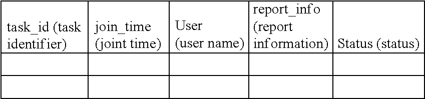

In Step S206, determining whether a delete action is received in the download area; if yes, proceeding with Step S207, otherwise, proceeding with Step S209.

In Step S207, deleting the download identifier corresponding to the delete operation.

In Step S208, generating the second report data based on the remained download identifier and displaying the second report data in the download area.

After the server generates the first report data based on the download identifier dragged into the download area by the user and displays the first report data in the download area, the user may screen the download identifiers in the download area to delete a download identifier corresponding to undesired data information. For example, the “the user logged in over the last week” is deleted, and after the “the user logged in over the last week” is deleted by the user, the server synchronously deletes the “the user logged in user the last week” and all the report data associated with the “the logged in user over the last week”, generates the second report data based on the remained download identifier, and displays the second report data in the download area.

In the embodiment, the user may perform a further delete operation on the selected download identifiers after the first report data is generated, generate the second report data based on the remained download identifier, and display the second report data in the download area. Therefore, the effect of data reduction is achieved.

In Step S209, receiving a downloading request and sending the current report data to the download terminal.

A download button is provided in the download area. The user clicks the download button to send a downloading request including the second report data after screening the download identifiers in the download area. The server sends the second report data to the download terminal after receives the downloading request.

Surely, in a case where the user directly click the download button instead of deleting the download identifier corresponding to the first report data when the first report data is generated, the server sends the first report data to the download terminal.

In the embodiment, the user enters into the report information page to view the report and the basic data of the report. In the viewing process, the user may drag the required row of information (the data on the specific date) into the download shopping cart, and may also drag the column information such as the dimension, or the index, such that the user's information associated with the screening condition is recorded in the shopping cart by the system. The user enters into the download shopping cart for download tasks, and performs secondary screening to the generated download tasks, and then performs download such that the exact data is exported to the local position.

A specific row or column, or multiple rows or columns may be selected by a mouse and dragged into the download task list according to the disclosure, such that the downloaded data is more cost-effective and the download of undesired data is reduced, which is more intuitive and clear, the size and downloading rate of the file to be downloaded are improved.

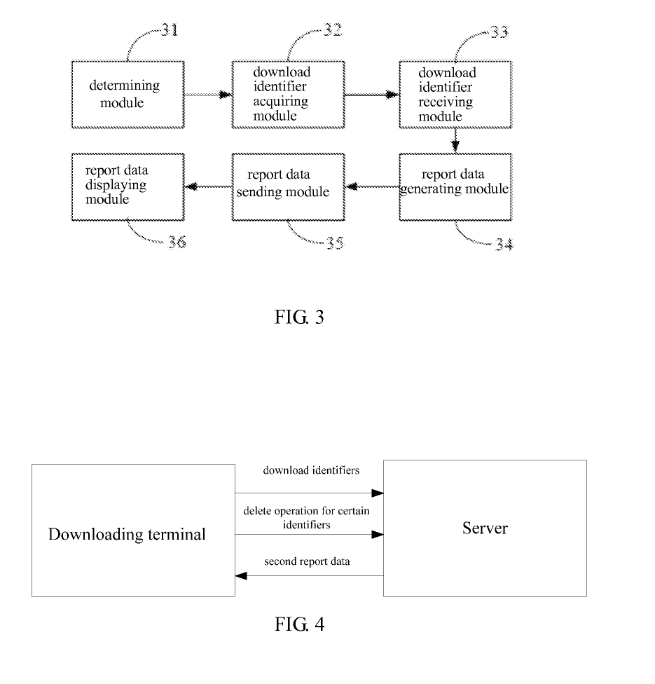

FIG. 3 is the structure schematic diagram of the server according to the embodiment of the disclosure, in which the server includes a determining module 31, a download identifier processing module 32, a download identifier receiving module 33, a report data generating module 34, a report data displaying module 35 and a report data sending module 36.

The determining module 31 determines whether the action of selecting the report information by the user is detected in the display area; if the determining module 31 determines that the action of selecting the report information by the user is detected, the download identifier processing module 32 acquires the download identifier in the report information.

The download identifier receiving module 33 receives the download identifier acquired by the download identifier processing module 32 as the user drags the selected report information into the download area.

The action of selecting the report information includes: selecting report information by a mouse, or selecting the report information by a touch action in the touch screen interface. The dragging operation includes: dragging the selected report information by a mouse, or dragging the selected report information by a touch action in the touch screen interface.

The report data generating module 34 generates the first report data according to the received download identifier, wherein the first report data is associated with the received download identifier. The report data displaying module 35 displays the first report data in the download area.

The determining module 31 determines whether the delete operation is received in the download area, wherein the delete operation corresponds to the download identifier in the download area; if the determining module determines that the delete operation is received in the download area, the report data generating module 34 receives the delete operation for the received download identifier and generates the second report data based on the remained download identifier. The report data displaying module 35 displays the second report data in the download area.

In the specific implementation process, a download button is provided in the download area, which button is configured to send the downloading request to the server for acquiring the report data in the current download area as a click operation is received. The report data includes the first report data or the second report data. When the downloading request is received, the report data sending module 36 sends the first report data or the second report data based on the received downloading request.

Reference is made to FIG. 4, which shows a hardware structure diagram according to an embodiment of the invention. In FIG. 4, the server receives the download identifiers from the download terminal, then receives delete operation for deleting some of the download identifiers, and finally sends the second report data to the download terminal.

For the operating principles of the modules of the server, please refer to the detailed description of the method for processing the data and the description thereof will be omitted.

In the embodiment, when browsing the report information, the user may directly drag the download identifier into the download area by a drag action and perform screening on the download identifiers in the download area; the server sends the corresponding report data to the download terminal based on download identifier screened by the user. Apparently, in the embodiment, the download identifier may be directly dragged into the download area in a simple way; and the download identifier may be screened in the download area, with only the required download identifier being remained. Since the server only sends the report data required by the user to the download terminal, the resources waste may be avoided and the download rate may be improved.

It should be noted that, for the method for processing report data according to the embodiment of the disclosure, it will be understood by the ordinary skilled in the art that part or all of the procedure of the method for processing report data according to the embodiment of the disclosure may be implemented by controlling related hardware through a computer program, the computer program may be stored in a computer readable storage medium such as the memory of the server and is executed by at least one processor in the server. The implementation process may include the procedure of the method embodiments in FIG. 1 and FIG. 2, where the storage medium may be disk, CD, ROM or RAM.

For the server according to the embodiment of the disclosure, its functional modules may be integrated into one processing chip, or each module may be physically independent, or two or more modules may be integrated into one module. The integrated modules may be implemented by hardware or by software functional modules. The integrated modules may be also stored in a computer readable storage medium such as ROM, disk or CD in a case where the modules are implemented by software functional module and sold or used as a stand-alone product.

In summary, although the present disclosure has been disclosed in the preferred embodiment described above, the foregoing preferred embodiments are not intended to limit the disclosure. Various changes and retouching can be made by the ordinary skilled in the art without departing from the spirit and scope of the present disclosure and therefore the scope of the protection should be subject to the scope defined in the claims.

1. A method for processing report data implemented by a server having one or more processors and memory for storing programs to be executed by the one or more processors, the method comprising:
providing, by the server, a download area in a user interface of a terminal;
receiving, by the server, download identifiers dragged into the download area;
generating a first report data associated with the download identifiers;
displaying the first report data in the download area;
receiving a delete operation for deleting one or more download identifiers from the download area, and obtaining the download identifiers remained in the download area after the delete operation;
generating a second report data associated with the download identifiers remained in the download area, wherein the second report data corresponds to the download identifiers remained in the download area; and
displaying the second report data in the download area.

2. The method of claim 1, wherein before receiving the download identifiers, the method further comprising:
determining whether an action of selecting report information by a user is detected in a displaying area;
acquiring the download identifier from the report information in a case where the action of selecting the report information by the user is detected;
receiving the acquired download identifier in a case where the user drags the selected report information into the download area by the drag operation.

3. The method of claim 2, wherein
the action of selecting the report information comprises: selecting the report information by a mouse or selecting the report information by a touch action on a touch screen interface; and
the drag operation comprises: dragging the selected report information by the mouse, or dragging the selected report information by the touch action on the touch screen interface.

4. The method of claim 1, wherein the receiving the delete operation for deleting one or more download identifiers comprises:
determining whether the delete operation is detected in the download area;
deleting the download identifier corresponding to the delete operation in a case where the delete operation is detected in the download area.

5. The method of claim 1, wherein a download button is provided in the download area, the download button is configured to send a downloading request to a server to acquire report data in a current download area upon receiving a click operation, wherein the report data comprises the first report data or the second report data formed by screening the first report data.

6. The method of claim 1, further comprising:
sending the second report data based on a received downloading request.

7. A server for processing report data, the server comprising:
one or more processors; and
memory storing one or more programs to be executed by the one or more processors, the one or more programs comprising instructions for:
a download identifier receiving module configured to receive download identifiers dragged into the download area;
a report data generating module configured to generate a first report data associated with the download identifier, receive a delete operation for deleting one or more download identifiers, and generate a second report data associated with the download identifier remained in the download area; wherein the first report data is associated with the download identifiers, and the second report data corresponds to the remained download identifier;
a report data displaying module configured to display the first report data and the second report data in the download area.

8. The server of claim 7, further comprising
a report data sending module configured to send the second report data based on a received downloading request.

9. The server of claim 7, further comprising a determining module, a download identifier acquiring module, and a report data sending module, wherein,
the determining module is configured to determine whether an action of selecting report information by a user is detected in a displaying area; and
the download identifier acquiring module is configured to acquire the download identifiers from the report information in a case where the determining module determines the action of selecting the report information by the user is detected in the displaying area; and
the download identifier receiving module is configured to receive the download identifiers acquired by the download identifier acquiring module in a case where the selected report information is dragged into the download area by the drag operation.

10. The server according to claim 9, wherein
the action of selecting the report information comprises: selecting the report information by a mouse, or selecting the report information by a touch action on a touch screen interface; and
the drag operation comprises: dragging the selected report information by a mouse, or dragging the selected report information by a touch action on the touch screen interface.

11. The server of claim 7, further comprising a determining module configured to determine whether a delete action is detected in the download area;
wherein the report data generating module deletes the download identifiers corresponding to the delete operation and generates the second report data associated with the download identifiers remained in the download area in a case where the determining module determines the delete action is detected in the download area.

12. The server of claim 7, wherein a download button is provided in the download area, wherein the download button is configured to send a downloading request to the server to acquire the report data in the current download area upon receiving a click operation; the report data comprises the first report data or the second report data formed by screening the first report data.

13. A non-transitory computer-readable medium containing computer-executable software instructions wherein the software instructions when being executed by the server, cause the server to perform steps for processing report data, the steps comprising:
providing a download area in a user interface of a user terminal;
receiving download identifiers dragged into the download area;
generating a first report data associated with the download identifiers;
displaying the first report data in the download area;
receiving a delete operation for deleting one or more download identifiers from the download area, and obtaining the download identifiers remained in the download area after the delete operation;
generating a second report data associated with the download identifiers remained in the download area, wherein the second report data corresponds to the download identifiers remained in the download area; and
displaying the second report data in the download area;

14. The computer-readable medium of claim 13, wherein before the receiving the download identifier dragged into the download area, the computer-executable software instructions further comprising:
determining whether an action of selecting report information by a user is detected in a displaying area;
acquiring the download identifier from the report information in a case where the action of selecting the report information by the user is detected;
receiving the acquired download identifier in a case where the user drags the selected report information into the download area by the drag operation.

15. The computer-readable medium of claim 14, wherein
the action of selecting the report information comprises: selecting the report information by a mouse or selecting the report information by a touch action on a touch screen interface; and
the drag operation comprises: dragging the selected report information by the mouse, or dragging the selected report information by the touch action on the touch screen interface.

16. The computer-readable medium of claim 13, wherein the receiving the delete operation for deleting one or more download identifiers comprises:
determining whether the delete operation is detected in the download area;
deleting the download identifier corresponding to the delete operation in a case where the delete operation is detected in the download area.

17. The computer-readable medium of claim 13, wherein a download button is configured in the download area, the download button configured to send a downloading request to a server to acquire report data in a current download area upon receiving a click operation, wherein the report data comprises the first report data or the second report data formed by screening the first report data, and the second report data is sent based on reception of the downloading request.

18. The computer-readable medium of claim 13, further comprising:
sending the second report data based on a received downloading request.
